(19) United States
(12) Patent Application Publication
(10) Pub. No.: US 2025/0181217 A1
(43) Pub. Date: Jun. 5, 2025

(54) PROCESSING METHOD, PROCESSING DEVICE, AND ELECTRONIC DEVICE

(71) Applicant: Lenovo (Beijing) Limited, Beijing (CN)

(72) Inventors: Liang ZHANG, Beijing (CN); Yu YANG, Beijing (CN)

(21) Appl. No.: 18/962,746

(22) Filed: Nov. 27, 2024

(30) Foreign Application Priority Data
Nov. 30, 2023 (CN) 202311631250.0

(51) Int. Cl. G06F 3/0484

(52) U.S. Cl. CPC G06F 3/0484

(57) ABSTRACT

A processing method includes displaying a target window in a first display zone of a display screen. A display area of the display screen includes an arc edge. A target edge of the first display zone coincides with the arc edge of the display area. A target part of a first graphical interaction interface of the target window is not displayed. The method further includes obtaining a first input operation, and, in response to the first input operation, displaying the target part in a second display zone. The second display zone is part of the first display zone and does not coincide with the target edge of the first display zone. The method also includes obtaining a second input operation for the target part, and, in response to the second input operation, displaying a second graphical interaction interface in the first display zone based on the target window.

### CROSS-REFERENCE TO RELATED APPLICATION

This application claims priority to Chinese Patent Application No. 202311631250.0, filed on Nov. 30, 2023, the entire content of which is incorporated herein by reference.

### TECHNICAL FIELD

The present disclosure generally relates to the field of communication technologies and, more particularly, to a processing method, a processing device, and an electronic device.

### BACKGROUND

With the rapid development of electronic devices, users have higher and higher requirements for screens of the electronic devices. To increase a screen-to-body ratio and pursue a full-screen display effect, components such as camera modules and facial recognition modules are usually omitted from the screen, resulting in the display screen not being a standard quadrilateral and affecting display effect.

### SUMMARY

In accordance with the present disclosure, there is provided a processing method including displaying a target window in a first display zone of a display screen. A display area of the display screen includes an arc edge. A target edge of the first display zone coincides with the arc edge of the display area. A target part of a first graphical interaction interface of the target window is not displayed. The method further includes obtaining a first input operation, and, in response to the first input operation, displaying the target part in a second display zone. The second display zone is part of the first display zone and does not coincide with the target edge of the first display zone. The method also includes obtaining a second input operation for the target part, and, in response to the second input operation, displaying a second graphical interaction interface in the first display zone based on the target window.

Also in accordance with the present disclosure, there is provided an electronic device including a display screen, a memory storing a computer program, and a processor. A display area of the display screen has an arc edge. The processor is configured to execute the computer program to display a target window in a first display zone of the display screen. A target edge of the first display zone coincides with the arc edge of the display area, and a target part of a first graphical interaction interface of the target window is not displayed. The processor is further configured to execute the computer program to, in response to a first input operation, display the target part in a second display zone that is part of the first display zone and does not coincide with the target edge of the first display zone, and, in response to a second input operation for the target part, display a second graphical interaction interface in the first display zone based on the target window.

Also in accordance with the present disclosure, there is provided a non-transitory computer-readable storage medium storing a computer program that, when executed by a processor, causes the processor to display a target window in a first display zone of a display screen. A display area of the display screen includes an arc edge, a target edge of the first display zone coincides with the arc edge of the display area, and a target part of a first graphical interaction interface of the target window is not displayed. The computer program further causes the processor to, in response to a first input operation, display the target part in a second display zone that is part of the first display zone and does not coincide with the target edge of the first display zone, and, in response to a second input operation for the target part, display a second graphical interaction interface in the first display zone based on the target window.

### BRIEF DESCRIPTION OF THE DRAWINGS

FIG. 1 is a flowchart of a processing method consistent with the present disclosure.

FIG. 2 is a schematic structural diagram of a display screen consistent with the present disclosure.

FIG. 3 is a schematic structural diagram of another display screen consistent with

the present disclosure.

FIG. 4 is a schematic diagram showing an interface of a display screen when running an application consistent with the present disclosure.

FIG. 5 is a schematic diagram showing another interface of a display screen when running an application consistent with the present disclosure.

FIG. 6 is a schematic diagram showing an interface of another display screen when running an application consistent with the present disclosure.

FIG. 7 is a schematic diagram showing an interface of another display screen when running an application consistent with the present disclosure.

FIG. 8 is a flowchart of another processing method consistent with the present disclosure.

FIG. 9 is a schematic diagram showing a change of an interface of a display screen when executing a processing method consistent with the present disclosure, where part A schematically shows that a target window is located in a first display zone of the display screen; part B schematically shows that a target part is located in a second display zone; part C schematically shows that a second input operation is performed on the target part; and part D schematically shows that the target window displays a second graphical interaction interface in the first display zone.

FIG. 10 is a flowchart of another processing method consistent with the present disclosure.

FIG. 11 is a schematic diagram showing a change of an interface of a display screen when executing a processing method consistent with the present disclosure, where part A schematically shows a target window in a first display state; part B schematically shows the target window in a second display state; part C schematically shows performing a second input operation on a target part; and part D schematically shows the target window displaying a second graphical interaction interface in the first display zone.

FIG. 12 is a schematic diagram showing a target window in a second display state when executing a processing method consistent with the present disclosure.

FIG. 13 is another schematic diagram showing a target window in a second display state when executing a processing method consistent with the present disclosure.

FIG. 14 is a schematic diagram of a processing device consistent with the present disclosure.

FIG. 15 is a schematic structural diagram of an electronic device consistent with the present disclosure.

FIG. 16 is a schematic structural diagram of another electronic device consistent with the present disclosure.

### DETAILED DESCRIPTION OF THE EMBODIMENTS

Specific embodiments of the present disclosure are hereinafter described with reference to the accompanying drawings. The described embodiments are merely examples of the present disclosure, which may be implemented in various ways. Specific structural and functional details described herein are not intended to limit, but merely serve as a basis for the claims and a representative basis for teaching one skilled in the art to variously employ the present disclosure in substantially any suitable detailed structure. Various modifications may be made to the embodiments of the present disclosure. Thus, the described embodiments should not be regarded as limiting, but are merely examples. Those skilled in the art will envision other modifications within the scope and spirit of the present disclosure.

Based on requirements on functions and layouts of parts of an electronic device, a structure of a display screen is optimized without affecting the appearance of the display screen of the electronic device. Functional modules are placed under the display screen to improve the overall display effect of the display screen. There is a problem that some contents cannot be displayed on the display screen. The existing solution usually uses an API interface to allow third-party applications (apps) to query the specific locations of the area on the display screen where the content cannot be displayed. When designing the interaction interface, interactive controls are set to avoid these locations, thereby avoiding displaying important content or content that needs to receive touch events in those locations. For a large number of third-party apps, it is difficult to adapt and the development cost is high.

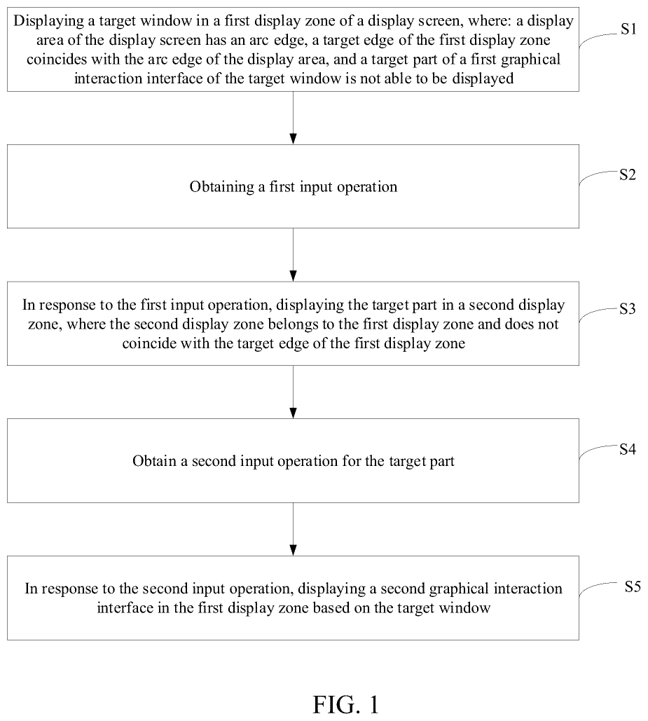

The present disclosure provides a processing method. As shown in FIG. 1, which is a flowchart of a processing method consistent with the present disclosure, in one embodiment, the method includes S1 to S5.

At S1, a target window is displayed in a first display zone of a display screen. A display area of the display screen may have an arc edge. A target edge of the first display zone may coincide with the arc edge of the display area, and a target part of a first graphical interaction interface of the target window may not be able to be displayed.

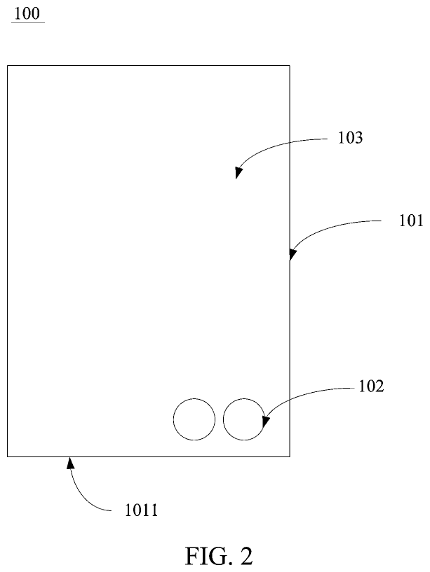

For example, in one embodiment, taking a punch hole screen as an example, the display screen may be punched to form a hole, and functional modules such as a camera or a face recognition module may be installed in the hole, such that the functional modules occupy a small visible area of the display screen. The hole area may be set at any position such as at the top, lower, or middle of the display screen. As shown in FIG. 2, which is a schematic structural diagram of a display screen, the display screen 100 may include an outer edge 101 and inner edges 102, and the inner edges 102 may not coincide with the outer edge 101. The inner edges 102 may be disposed in the lower part of the display screen 100. The inner edges 102 may be set to one or more according to the number or size of the functional modules. As shown in FIG. 2, in one embodiment, there may be two inner edges 102. The outer edge 101 may be a quadrilateral, and the area surrounded by the outer edge 101 may be the first display zone 103 of the display screen 100. One inner edge 102 may be a closed arc, and the arc of the inner edge 102 may be set to an arc structure such as a circle, an ellipse or a water drop shape according to the size or shape of the functional modules of the electronic device. The inner edge 102 may be the arc edge of the display area, and the target edge of the first display zone 103 may coincide with the arc edge. The inner edges 102 may be close to the first edge 1011 of the outer edge 101, e.g., the inner edges 102 is closer to the first edge 1011 than other parts of the outer edge 101. The first edge 1011 is a part of the outer edge 101, and is also referred to as a “partial outer edge.”

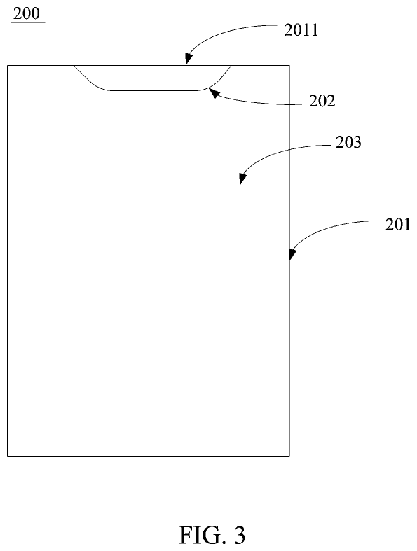

For another example, in another embodiment, the display screen may be a bangs screen. The bangs screen generally reserves a space at the top of the display screen for installing functional modules such as cameras or light sensors. As shown in FIG. 3 which is a schematic structural diagram of another display screen, the display screen 200 may include an outer edge 201 and an inner edge 202. The inner edge 202 may not coincide with the outer edge 201. The outer edge 201 may be a quadrilateral, and the area enclosed by the outer edge 201 may be the first display zone 203 of the display screen 200. The inner edge 202 may be a closed arc. The inner edge 202 may be an arc-shaped edge of the display area, and the target edge of the first display zone 203 may coincide with the arc-shaped edge. The inner edge 202 may be close to the first edge 2011 of the outer edge 201.

When an application installed in the electronic device is running, the target window may be displayed in the first display zone of the display screen, and the user may operate the application in the target window. When the user operates the application in the target window, the first graphical interaction interface of the target window may be partially changed and partially unchanged; or the content in the first graphical interaction interface of the target window may be completely changed, and the present disclosure does not limit this.

Taking the display screen 100 as an example, in one embodiment, the area of the target part of the first graphical interaction interface of the target window may overlap with the inner edge 102, and the target part cannot be displayed. Taking the display screen 200 as an example, in another embodiment, the area of the target part of the first graphical interaction interface of the target window may overlap with the inner edge 202, and the target part cannot be displayed.

S2, a first input operation is obtained.

In some embodiments, the first input operation may be triggered by a certain specific gesture, or by clicking, long pressing, sliding, etc. on the display screen. In another embodiment, a physical screen button may be set on the electronic device and the first input operation may be triggered by clicking the button. In yet another embodiment, the first input operation may be obtained by a quick voice command, etc. The present disclosure does not limit this.

S3, in response to the first input operation, the target part is displayed in a second display zone, where the second display zone belongs to the first display zone and does not overlap with the target edge of the first display zone.

The second display zone may belong to the first display zone. Since the second display zone is used to display the target part that cannot be displayed in the first display zone, the second display zone may not overlap with the target edge of the first display zone.

In one embodiment, taking the display screen 100 as an example, the second display zone 104 may be located above the inner edge 102 to avoid the inner edge 102. In another example, when the inner edge is located on the left side of the display screen, the second display zone may also be set on the right side of the inner edge. In another embodiment, taking the display screen 200 as an example, the second display zone 204 may be located below the inner edge 202 to avoid the inner edge 202.

S4, a second input operation for the target part is obtained.

The second input operation may include triggering operations such as click, long press, or slide, and the user may interact with the target part by operating the target part.

S5, in response to the second input operation, the second graphical interaction interface is displayed in the first display zone based on the target window.

By performing the second input operation on the target part, the content of the application may change, the first graphical interaction interface of the target window may be converted to the second graphical interaction interface, and the second graphical interaction interface of the target window may be displayed in the first display zone. Since the second display zone belongs to the first display zone, when the second graphical interaction interface of the target window is displayed in the first display zone, the target part of the second display zone may be replaced by the content in the second graphical interaction interface. That is, in response to the second input operation, not only the second graphical interaction interface may be displayed in the first display zone based on the target window, but also the target part may not be displayed. When the second display interface needs to be redisplayed, the first input operation may be obtained again.

In one embodiment, a time threshold may also be set to control the content of the second display zone to be replaced by the content of the first graphical interaction interface. For example, the time threshold may be 10 s. When the user does not trigger the second input operation within 10 s, the content in the second display zone may be replaced by the content of the first graphical interaction interface, and the first graphical interaction interface of the target window may be displayed in the first display zone.

In the present disclosure, the target window may be displayed in the first display zone of the display screen, the display area of the display screen may have an arc-shaped edge, and the target edge of the first display zone may coincide with the arc-shaped edge of the display area. The target part of the first graphical interaction interface of the target window may be unable to be displayed. Then, the first input operation may be obtained, and, in response to the first input operation, the target part that is unable to be displayed in the first graphical interaction interface may be displayed in the second display zone. The second input operation may also be performed on the target part in the second display zone, the first graphical interaction interface of the target window may be converted to the second graphical interaction interface, and the second graphical interaction interface may be displayed in the first display zone. The development of a separate application for the display screen with the arc-shaped edge in the display area may not be required to enable the normal display of the target part. Also, there may be no need to set interactive controls to avoid the arc-shaped edge, and the user may be able to interact with the target part through the second input operation.

In one embodiment, displaying the target part in the second display zone may include:
adjusting the target window from a first display state to a second display state; and
displaying the target window in the second display state.

The target window in the second display state may occupy the second display zone, and the target window in the second display state displaying the first graphical interaction interface may be able to display the target part.

When the target window is in the first display state, the target part of the first graphical interaction interface of the target window cannot be displayed. After the target window is adjusted from the first display state to the second display state, the target part of the first graphical interaction interface of the target window may be displayed in the second display state.

In one embodiment, adjusting the target window from the first display state to the second display state may include:
obtaining the second display zone;
based on the second display zone, adjusting the size of the target window to be the
same as the second display zone.

The second display zone may be a quadrilateral and may overlap with the non-target edge of the first display zone. The second display zone may be tangent to the target edge of the first display zone.

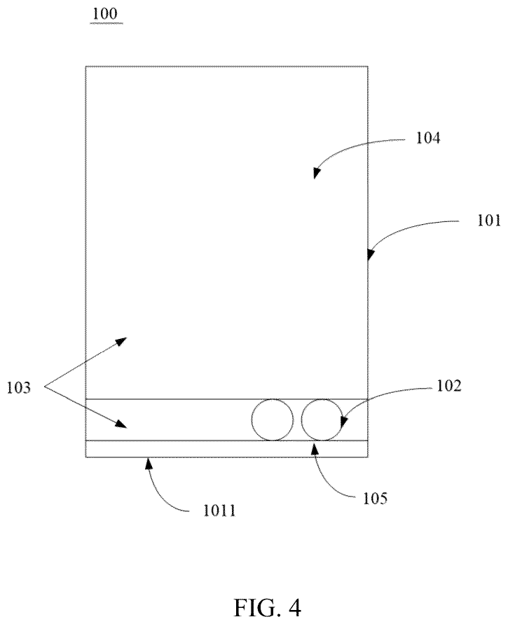

In one embodiment, as shown in FIG. 4, taking the display screen 100 as an example, to improve the utilization rate of the display screen and enhance the display effect of the display screen, the second display zone 104 may be used to display other parts of the first graphical interaction interface of the target window in addition to the target part. The second display zone 104 may overlap with the non-target edge of the first display zone 103, and the second display zone 104 may be tangent to the target edge of the first display zone 103. The non-target edge of the first display zone 103 may be a part of the first display zone 103 without the target edge.

For example, the first graphical interaction interface of the target window may be moved translationally upward until the size of the target window is the same as that of the second display zone. When the arc area of the display screen is on the left side of the display screen, the first graphical interaction interface of the target window may be moved translationally to the right until the size of the target window is the same as that of the second display zone.

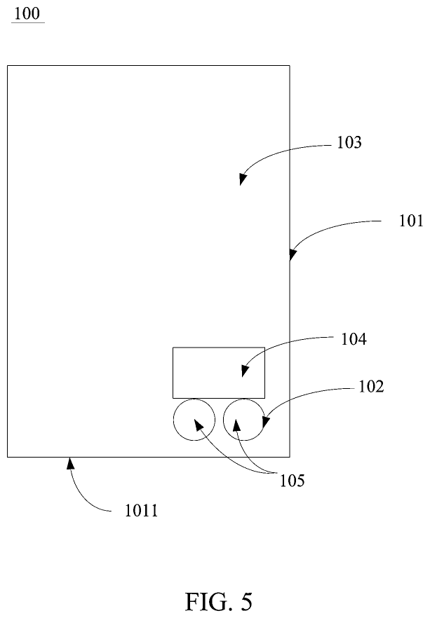

As shown in FIG. 5, still taking the display screen 100 as an example, the second display zone 104 may be only used to display the target part, and the size of the second display zone 204 may be the same as the size of the area occupied by the target part. The second display zone 104 may overlap with the non-target edge of the first display zone 103, and the second display zone 104 and the target edge of the first display zone 103 may be tangent or not tangent, which is not limited in the present disclosure.

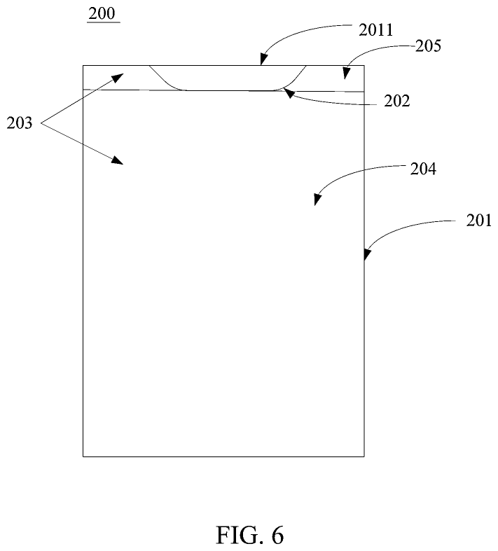

As shown in FIG. 6, taking the display screen 200 as an example, to improve the utilization rate of the display screen and enhance the display effect of the display screen, the second display zone 204 may also be used to display other parts of the first graphical interaction interface of the target window in addition to the target part. The second display zone 204 may overlap with the non-target edge of the first display zone 203, and the second display zone 204 may be tangent to the target edge of the first display zone 203. The non-target edge of the first display zone 203 may be the portion of the first display zone 203 minus the target edge.

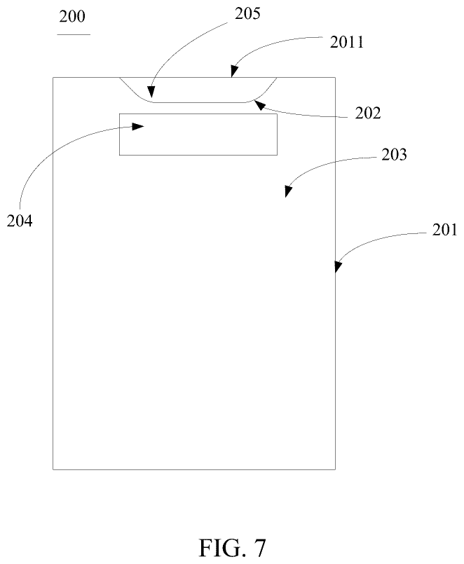

As shown in FIG. 7, taking the display screen 200 as an example, the second display zone 204 may be only used to display the target part, and the size of the second display zone 204 may be the same as the size of the area occupied by the target part. The second display zone 204 may overlap with the non-target edge of the first display zone 203, and the second display zone 204 and the target edge of the first display zone 203 may be tangent or not tangent, which is not limited in the present disclosure.

In one embodiment, displaying the target portion in the second display zone may include:
obtaining the target part of the first graphical interaction interface; and
displaying the target part on the first graphical interaction interface in an overlay manner, where the target part occupies the second display zone.

The target part of the first graphical interaction interface may be obtained by obtaining an image of the first graphical interaction interface and determining the target part from the image. The target part may then be overlaid on the first graphical interaction interface and displayed in the second display zone. The target part may also be overlaid on the first graphical interaction interface based on window overlay and displayed in the second display zone.

Taking the display screen 200 shown in FIG. 7 as an example, the target part of the first graphical interaction interface of the target window cannot be displayed. After the target part is obtained, it may be displayed in the second display zone 204. The user may continue to perform the second input operation such as clicking or long pressing on the target part in the second display zone 204.

In one embodiment, after obtaining the second input operation, the method may further include:
determining first position information of the second input operation in the second display zone in response to the second input operation;
determining second position information based on the first position information, where the second position information is information about the position of the target edge of the first display zone associated with the second display zone; and
performing the second input operation based on the second position information.

When the user performs the second input operation such as clicking, long pressing, double-clicking, sliding, etc. in the second display zone, the position information of the second input operation may need to be remapped to its original position. When the position of the second display zone is fixed, a mapping relationship between the position information of the second display zone and the target edge of the first display zone may be established according to the size of the second display zone, and the second position information may be determined from the mapping relationship based on the first position information.

In one embodiment, obtaining the first input operation may include:
obtaining the first input operation based on a target acquisition area.

The display screen may include an outer edge and an inner edge. The outer edge may be a quadrilateral, the inner edge may be a closed arc, and the inner edge may be close to the first edge of the outer edge. The inner edge may not overlap with the outer edge. The target edge of the first display zone may overlap with the inner edge, and the target acquisition area may be located between the inner edge and the first edge.

Taking the display screen 100 shown in FIG. 4 as an example, the target acquisition area 105 may be located between the inner edge 102 and the first edge 1011.

Taking the display screen 200 shown in FIG. 6 as another example, the target acquisition area 205 may be located between the inner edge 202 and the first edge 2011.

A gesture triggered in the target acquisition area, or triggering methods such as clicking, long pressing, sliding, etc., may be used to obtain the first input operation.

In one embodiment, obtaining the first input operation may also include:
obtaining an input point of the target acquisition area based on the target acquisition area; and
determining the first input operation based on the input point.

The display screen may include an outer edge and an inner edge. The outer edge may be a quadrilateral, the inner edge may be a closed arc, and the inner edge may be close to the first edge of the outer edge. The inner edge may not overlap with the outer edge, and the inner edge may be the target edge. The target acquisition area may be located between the inner edge and the first edge; or the target acquisition area may be the area formed by the inner edge.

The input point may not be used to notify the application corresponding to the target window; or, the first input operation may not be used to notify the application corresponding to the target window.

Taking the display screen 100 shown in FIG. 4 and FIG. 5 as an example, in one embodiment, the target acquisition area 105 may be an area formed by the inner edge 102, or the target acquisition area 105 may be located between the inner edge 102 and the first edge 1011.

Taking the display screen 200 shown in FIG. 6 and FIG. 7 as an example, in another embodiment, the target acquisition area 205 may be an area formed by the inner edge 202, or the target acquisition area 205 may be located between the inner edge 202 and the first edge 2011. In FIG. 6, the target acquisition area 205 is an area formed by the inner edge 202 as an example. The camera module may be arranged below the inner edge 202. When the user presses the target acquisition area 205, the camera module may recognize the pressing operation. The position of the pressing center may be determined according to the finger pressing area. The pressing center may be the input point, and the first input operation may be determined based on the input point. To prevent the application from responding to the input point or the first input operation, the input point or the first input operation may not be used to notify the application corresponding to the target window.

An embodiment with an application scenario of the present disclosure will be used to describe the present disclosure below, where the display screen takes the display screen 100 shown in FIG. 4 as an example and the application takes WeChat as an example.

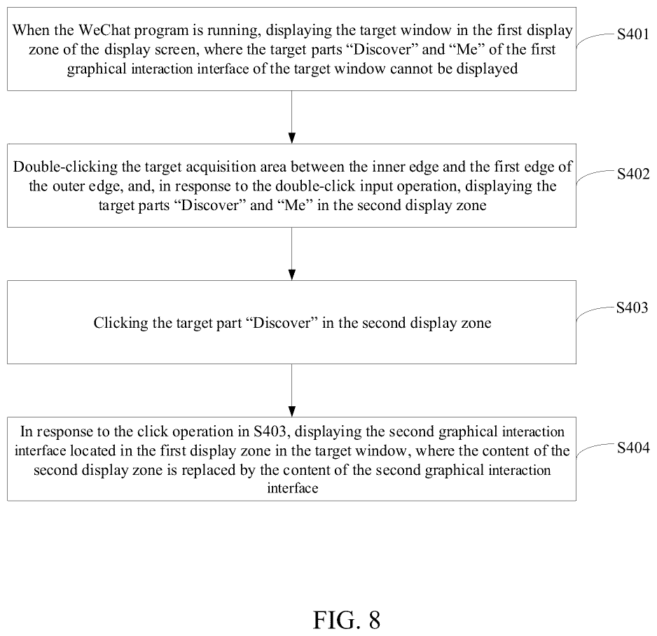

As shown in FIG. 8, which is a flow chart of a processing method, in one embodiment, the method includes S401-S404.

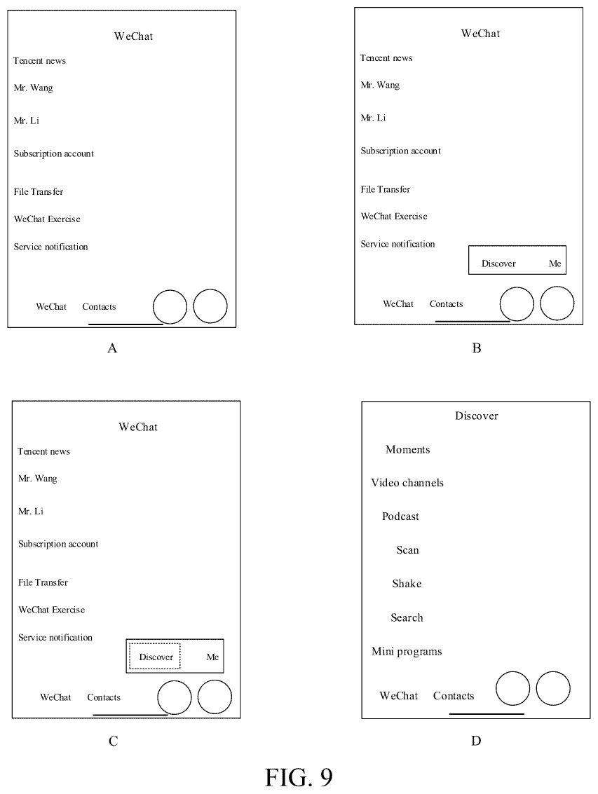

S401, when the WeChat program is running, displaying the target window in the first display zone of the display screen, where the target parts “Discover” and “Me” of the first graphical interaction interface of the target window cannot be displayed. For example, part A of FIG. 9 schematically shows that the target window is located in the first display zone of the display screen.

S402, double-clicking the target acquisition area between the inner edge and the first edge of the outer edge, and, in response to the double-click input operation, displaying the target parts “Discover” and “Me” in the second display zone. For example, part B of FIG. 9 schematically shows that the target parts are located in the second display zone.

S403, clicking on the target part “Discover” in the second display zone. For example, part C of FIG. 9 schematically shows performing the second input operation on the target part.

S404, in response to the click operation in S403, displaying the second graphical interaction interface located in the first display zone in the target window, where the content of the second display zone is replaced by the content of the second graphical interaction interface. For example, part D of FIG. 9 schematically shows that the target window displays the second graphical interaction interface located in the first display zone.

Another embodiment with another application scenario of the present disclosure will be used to describe the present disclosure below, where the display screen takes the display screen 100 shown in FIG. 5 as an example and the application takes WeChat as an example.

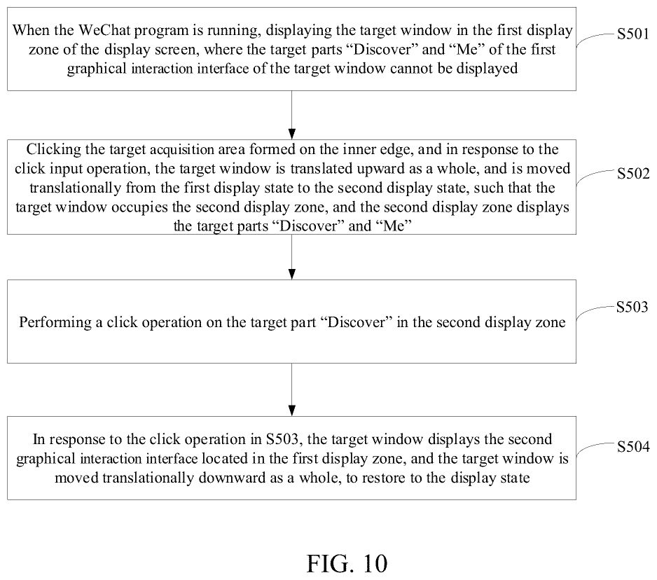

As shown in FIG. 10 which is a flow chart of a processing method, in another embodiment, the method includes S501-S504.

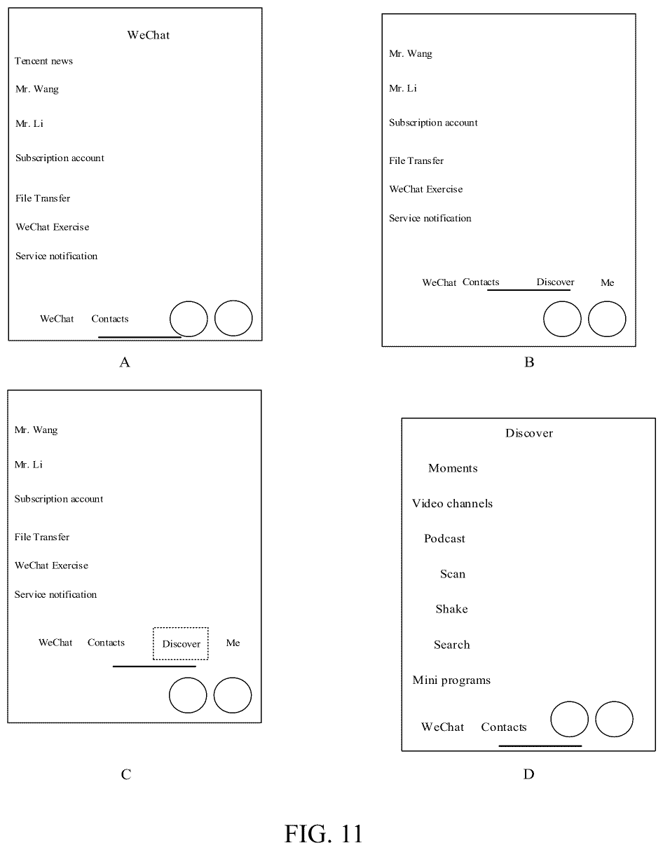

S501, when the WeChat program is running, displaying the target window in the first display zone of the display screen, where the target parts “Discover” and “Me” of the first graphical interaction interface of the target window cannot be displayed. For example, part A of FIG. 11 schematically shows that the target window in the first display state.

The target window may be a window formed by the outer frame of the display screen, that is, including the window where the upper “WeChat” and the lower “Chat” and “Contact” are located in part A of FIG. 11. The target window may also not include the window where the upper “WeChat” is located in part A of FIG. 11. Among them, the lower “Chat,” “Contacts” in part A of FIG. 11, and the “Discover” and “Me” that cannot be displayed may all be controls, which are used to interact with the user and receive touch operations.

S502, click on the target acquisition area formed on the inner edge, and in response to the click input operation, the target window may be moved translationally upward as a whole, and the target window may be adjusted from the first display state to the second display state. The target window may occupy the second display zone, and the second display zone may display the target parts “Discover” and “Me.”

Taking the target window including the window where the upper “WeChat” and the lower “Chat” and “Contact” are located as an example, since the target window is moved translationally upward as a whole, the effective display area on the display screen may become smaller, and the current display interface may change, that is, the “WeChat” in the upper window may be moved to a point where it cannot be displayed in the display area. The content in the display interface may also be moved upward as a whole. At this time, the schematic diagram showing the target window in the second display state is shown in part B of FIG. 11.

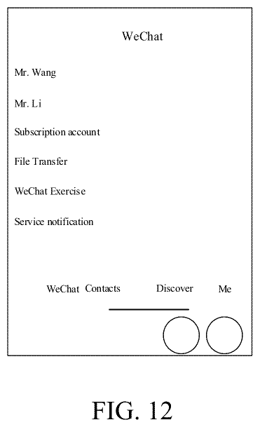

Taking the target window that does not include the window where the upper “WeChat” in part A of FIG. 11 as another example, the content of the display area may be moved translationally upward as a whole. At this time, the schematic diagram showing the second display state of the target window is shown in FIG. 12. The difference from part B of FIG. 11 is that the upper “WeChat” window is retained.

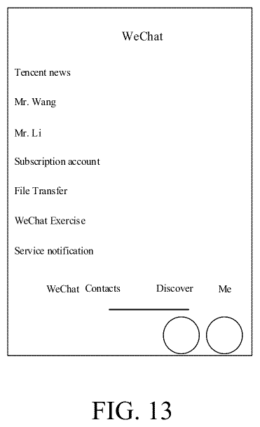

To fully display the content of the display area, the interface of the display area may also be reduced as a whole, and the content of the display area may also be reduced as the interface is reduced. At this time, the schematic diagram showing the second display state of the target window is shown in FIG. 13.

S503, following the example of part B of FIG. 11, a click operation is performed on the target part “Discover” in the second display zone, as shown in part C of FIG. 11 which is a schematic diagram showing the second input operation on the target part.

S504, in response to the click operation in step S503, the target window displays the second graphical interaction interface located in the first display zone, and the target window is moved translationally downward as a whole, to restore to the display state shown in part A of FIG. 11, that is, the target parts “Discover” and “Me” cannot be displayed, as shown in part D of FIG. 11 which is a schematic diagram showing the target window displaying the second graphical interaction interface located in the first display zone.

When it is necessary to perform a click operation on the target part “Me” in the second display zone, S502 may be repeated and a click operation may be performed on the target part “Me” in the second display zone.

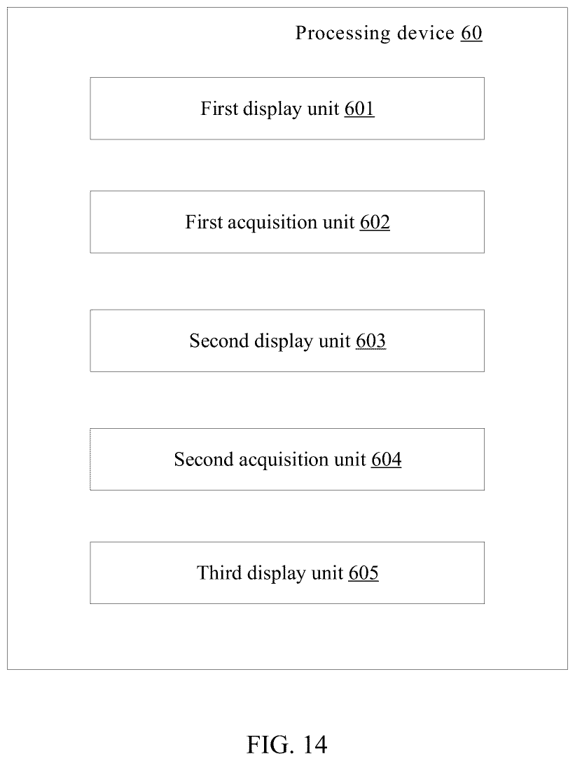

The present disclosure also provides a processing device. In one embodiment shown in FIG. 14 which is a schematic structural diagram of a processing device consistent with the present disclosure, the device 60 may include:
a first display unit 601, used to display a target window in a first display zone of a display screen, where the display area of the display screen has an arc edge, the target edge of the first display zone coincides with the arc edge of the display area, and the target part of the first graphical interaction interface of the target window cannot be displayed;
a first acquisition unit 602, used to obtain a first input operation;
a second display unit 603, used to respond to the first input operation and display the target part in the second display zone, where the second display zone belongs to the first display zone and does not coincide with the target edge of the first display zone;
a second acquisition unit 604, used to obtain a second input operation for the target part; and
a third display unit 605, used to respond to the second input operation and display the second graphical interaction interface in the first display zone based on the target window.

In one embodiment, the second display unit 603 may also be used to
adjust the target window from the first display state to the second display state;
display the target window in the second display state.

The target window in the second display state may occupy the second display zone and the first graphical interaction interface of the target window in the second display state may be able to display the target part.

In one embodiment, the second display unit 603 may also be used to:
obtain the second display zone;
adjust the size of the target window to be the same as the second display zone based on the second display zone, where the second display zone is a quadrilateral, overlaps with the non-target edge of the first display zone, and is tangent to the target edge of the first display zone.

In one embodiment, the second display unit 603 may also be used to:
obtain the target part of the first graphical interaction interface; and
superimpose and display the target part on the first graphical interaction interface, where the target part occupies the second display zone.

In one embodiment, the first acquisition unit 602 may also be used to:
obtain the first input operation based on the target acquisition area.

The display screen may include an outer edge and an inner edge. The outer edge may be a quadrilateral, the inner edge may be a closed arc and may be close to the first edge of the outer edge. The inner edge may not overlap with the outer edge. The target edge of the first display zone may overlap with the inner edge, and the target acquisition area may be located between the inner edge and the first edge.

In one embodiment, the first acquisition unit 602 may also be used to:
obtain the input point of the target acquisition area based on the target acquisition area; and
determine the first input operation based on the input point.

The display screen may include an outer edge and an inner edge. The outer edge may be a quadrilateral, the inner edge may be a closed arc and may be close to the first edge of the outer edge. The inner edge may not overlap with the outer edge. The inner edge may be the target edge. The target acquisition area may be located between the inner edge and the first edge or may be the area formed by the inner edge.

The input point may not be used to notify the application corresponding to the target window; or, the first input operation may not be used to notify the application corresponding to the target window.

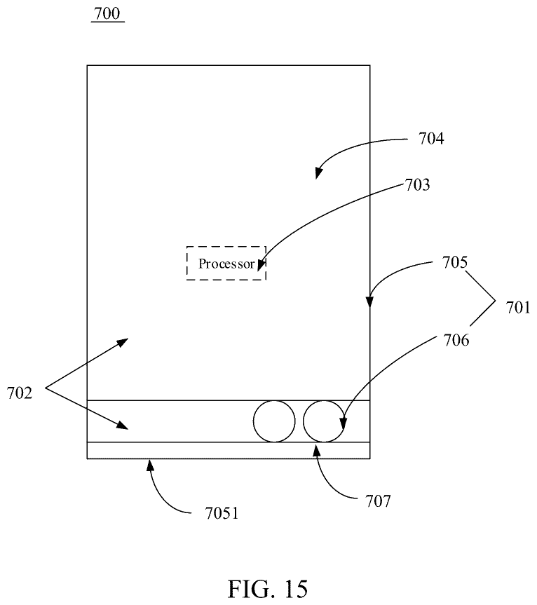

The present disclosure also provides an electronic device. In one embodiment, as shown in FIG. 15, which is a schematic structural diagram of the electronic device, the electronic device 700 includes a display screen 701, and a processor 703.

The display area of the display screen may have an arc edge. The first display zone 702 of the display screen may be used to display the target window, and the target edge of the first display zone 702 may coincide with the arc edge of the display area. The target part of the first graphical interaction interface of the target window cannot be displayed.

The processor 703 may be used to: respond to a first input operation to display the target part in the second display zone 704, where the second display zone 704 belongs to the first display zone 702 and does not coincide with the target edge of the first display zone 702; and in response to the second input operation, display the second graphical interaction interface in the first display zone 702 based on the target window.

In one example, the display screen 701 may include an outer edge 705 and an inner edge 706. The outer edge 705 may be a quadrilateral, the inner edge 706 may be a closed arc and is close to the first edge 7051 of the outer edge 705. The inner edge 706 may not overlap with the outer edge 7051, the inner edge 706 may be the target edge, and the target acquisition area 707 may be formed between the inner edge 706 and the first edge 7051; or the area formed by the inner edge 706 forms the target acquisition area 707.

In one example, the first input operation may be obtained based on the target acquisition area 707; or
the input point of the target acquisition area 707 may be obtained based on the target acquisition area 707 and the first input operation may be obtained based on the input point.

The present disclosure also provides a non-transitory computer-readable storage medium storing computer instructions, and the computer instructions may be used to enable a computer to execute the method described in the present disclosure.

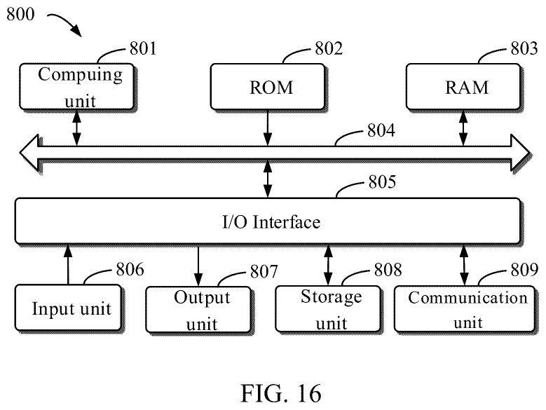

The present disclosure also provides an electronic device. FIG. 16 shows a schematic block diagram of an example electronic device 800 that may be used to implement any embodiment of the present disclosure. The electronic device is intended to represent various states of digital computers, such as laptop computers, desktop computers, workstations, personal digital assistants, servers, blade servers, mainframe computers, or other suitable computers. The electronic device may also represent various states of mobile devices, such as personal digital processing, cellular phones, smart phones, wearable devices or other similar computing devices. The components shown herein, their connections and relationships, and their functions are merely examples and are not intended to limit the implementation of the present disclosure described and/or required herein.

As shown in FIG. 16, in one embodiment, the device 800 may include a computing unit 801. The computing unit 801, e.g., a processor, may perform various appropriate actions and processes according to a computer program stored in a read-only memory (ROM) 802 or a computer program loaded from a storage unit 808 into a random access memory (RAM) 803. The RAM 803 may be also used to store various programs and data required for the operation of the device 800. The computing unit 801, the ROM 802, and the RAM 803 may be connected to each other through a bus 804. An input/output (I/O) interface 805 may also be connected to the bus 804.

Multiple components in the device 800, including: an input unit 806 (such as a keyboard, a mouse, etc.), an output unit 807 (such as various types of displays, speakers, etc.), a storage unit 808 (such as a disk, an optical disk, etc., or a communication unit 809 (such as a network card, a modem, a wireless communication transceiver, etc.) may be connected to the I/O interface 805 The communication unit 809 may enable the device 800 to exchange information/data with other devices through a computer network such as the Internet and/or various telecommunication networks.

The computing unit 801 may be a variety of general and/or special processing components with processing and computing capabilities. Some examples of the computing unit 801 include, but are not limited to, a central processing unit (CPU), a graphics processing unit (GPU), various dedicated artificial intelligence (AI) computing chips, various computing units running machine learning model algorithms, digital signal processors (DSPs), or any appropriate processors, controllers, microcontrollers, etc. The computing unit 801 may be able to perform the various methods and processes described above, such as the control method. For example, in some embodiments, the control method provided by various embodiments of the present disclosure may be implemented as a computer software program which is tangibly contained in a machine-readable medium, such as the storage unit 808. In some embodiments, part or all of the computer program may be loaded and/or installed on the device 800 via the ROM 802 and/or the communication unit 809. When the computer program is loaded into the RAM 803 and executed by the computing unit 801, part or all of the control method provided by various embodiments of the present disclosure may be performed. In some other embodiments, the computing unit 801 may be configured to perform the control method in any other appropriate manner (e.g., by means of firmware).

Various embodiments of the systems and techniques described above herein may be implemented in digital electronic circuit systems, integrated circuit systems, field programmable gate arrays (FPGAs), application specific integrated circuits (ASICs), application specific standard products (ASSPs), systems on chips (SOCs), complex programmable logic devices (CPLDs), computer hardware, firmware, software, and/or any combinations thereof. For example, they may be implemented in one or more computer programs. The one or more computer programs may be executed and/or interpreted on a programmable system including at least one programmable processor. One programmable processor may be a dedicated or general programmable processor, and may receive data and instructions from a storage system, at least one input device, or at least one output device, and transmit data and instructions to the storage system, the at least one input device, or the at least one output device.

The program codes for implementing the method disclosed herein may be written in any combination of one or more programming languages. These program codes may be provided to a processor or controller of a general-purpose computer, a dedicated computer, or other programmable data processing device, such that the program code, when executed by the processor or controller, enables the functions/operations specified in the flow chart and/or block diagram to be implemented. The program code may be executed entirely on the machine, partially on the machine, partially on the machine as an independent software package and partially on a remote machine or entirely on a remote machine or server.

In the present disclosure, a machine-readable medium may be a tangible medium that may contain or store a program for use by or in conjunction with an instruction execution system, device or equipment. The machine-readable medium may be a machine-readable signal medium or a machine-readable storage medium. The machine-readable medium may include, but is not limited to, electronic, magnetic, optical, electromagnetic, infrared, or semiconductor systems, devices or equipment, or any suitable combination thereof. A more specific example of a machine-readable storage medium may include an electrical connection based on one or more lines, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

To provide interaction with a user, the systems and techniques described herein may be implemented on a computer including a display device (e.g., a flexible OLED (organic light emitting diode)) for displaying information to the user and a keyboard and a pointing device (e.g., a mouse or trackball) through which the user can provide input to the computer. Other types of devices can also be used to provide interaction with the user; for example, the feedback provided to the user can be any state of sensory feedback (e.g., visual feedback, auditory feedback, or tactile feedback); and input from the user can be received in any state (including acoustic input, voice input, or tactile input).

The systems and techniques described herein may be implemented in a computing system including a backend component (e.g., as a data server), or a computing system including a middleware component (e.g., an application server), or a computing system including a frontend component (e.g., a user computer with a graphical user interface or a web browser through which a user can interact with an implementation of the systems and techniques described herein), or a computing system including any combination of such backend components, middleware components, or frontend components. The components of the system may be interconnected by digital data communication (e.g., a communication network) in any state or medium. Examples of communication networks include: a local area network (LAN), a wide area network (WAN), or the Internet.

A computer system may include a client and a server. The client and server may generally be remote from each other and typically interact through a communication network. The client and server relationship may be generated by computer programs running on respective computers and having a client-server relationship with each other. The server may be a cloud server, a server of a distributed system, or a server incorporating a blockchain.

It should also be noted that, in the present disclosure, relational terms such as first and second, etc. are only used to distinguish one entity or operation from another entity or operation, and do not necessarily require or imply that there is any such actual relationship or order between these entities or operations. It should also be noted that in the present disclosure, the terms “include,” “comprise” or any other variant thereof are intended to cover non-exclusive inclusion, such that a process, method, article or device including a series of elements includes not only those elements, but also other elements not explicitly listed, or also includes elements inherent to such process, method, article or device. In the absence of further restrictions, an element associated the sentence “includes one . . . ” does not exclude the presence of other identical elements in the process, method, article or device including the element. In this disclosure, “a plurality of” means two or more, unless otherwise specified.

Various embodiments have been described to illustrate the operation principles and exemplary implementations. It should be understood by those skilled in the art that the present disclosure is not limited to the specific embodiments described herein and that various other obvious changes, rearrangements, and substitutions will occur to those skilled in the art without departing from the scope of the present disclosure. Thus, while the present disclosure has been described in detail with reference to the above described embodiments, the present disclosure is not limited to the above described embodiments, but may be embodied in other equivalent forms without departing from the scope of the present disclosure.

What is claimed is:

1. A processing method comprising:
displaying a target window in a first display zone of a display screen, a display area of the display screen including an arc edge, a target edge of the first display zone coinciding with the arc edge of the display area, and a target part of a first graphical interaction interface of the target window not being displayed;
obtaining a first input operation;
in response to the first input operation, displaying the target part in a second display zone, the second display zone being part of the first display zone and not coinciding with the target edge of the first display zone;
obtaining a second input operation for the target part; and
in response to the second input operation, displaying a second graphical interaction interface in the first display zone based on the target window.

2. The processing method according to claim 1,
wherein displaying the target part in the second display zone includes:
adjusting the target window from a first display state to a second display state; and
displaying the target window in the second display state; and
wherein, the target window in the second display state occupies the second display zone and the first graphical interaction interface of the target window in the second display state is able to display the target part.

3. The processing method according to claim 2, wherein adjusting the target window from the first display state to the second display state includes:
obtaining the second display zone; and
adjusting a size of the target window to be same as the second display zone.

4. The processing method according to claim 3, wherein adjusting the size of the target window to be same as the second display zone includes adjusting the second display zone to be a quadrilateral that overlaps with a non-target edge of the first display zone and is tangent to the target edge of the first display zone.

5. The processing method according to claim 1, wherein displaying the target part in the second display zone includes:
obtaining the target part of the first graphical interaction interface; and
superimposing and displaying the target part on the first graphical interaction interface, the target part occupying the second display zone.

6. The processing method according to claim 1, wherein obtaining the first input operation includes obtaining the first input operation based on a target acquisition area.

7. The processing method according to claim 6, wherein:
the display screen includes an outer edge and an inner edge;
the outer edge is a quadrilateral;
the inner edge is a closed arc, is close to a part of the outer edge, and does not overlap with the outer edge;
the target edge of the first display zone overlaps with the inner edge; and
the target acquisition area is located between the inner edge and the part of the outer edge.

8. The processing method according to claim 1, wherein obtaining the first input operation includes:
obtaining, based on a target acquisition area, an input point of the target acquisition area; and
determining the first input operation based on the input point.

9. The processing method according to claim 8, wherein:
the display screen includes an outer edge and an inner edge;
the outer edge is a quadrilateral;
the inner edge is a closed arc, is close to a part of the outer edge, and does not overlap with the outer edge;
the inner edge is the target edge; and
the target acquisition area is located between the inner edge and the first edge or is an area formed by the inner edge.

10. An electronic device comprising:
a display screen, a display area of the display screen including an arc edge;
a memory storing a computer program; and
a processor configured to execute the computer program to:
display a target window in a first display zone of the display screen, a target edge of the first display zone coinciding with the arc edge of the display area, and a target part of a first graphical interaction interface of the target window not being displayed;
in response to a first input operation, display the target part in a second display zone, the second display zone being part of the first display zone and not coinciding with the target edge of the first display zone; and
in response to a second input operation for the target part, display a second graphical interaction interface in the first display zone based on the target window.

11. The electronic device according to claim 10, wherein:
the display screen includes an outer edge and an inner edge;
the outer edge is a quadrilateral;
the inner edge is a closed arc, is close to a part of the outer edge, and does not overlap with the outer edge;
the inner edge is the target edge; and
an area between the inner edge and the first edge forms a target acquisition area, or an area formed by the inner edge forms the target acquisition area.

12. The electronic device according to claim 10, wherein:
the processor is further configured to execute the computer program to, when displaying the target part in the second display zone:
adjust the target window from a first display state to a second display state; and
display the target window in the second display state; and
the target window in the second display state occupies the second display zone and the first graphical interaction interface of the target window in the second display state is able to display the target part.

13. The electronic device according to claim 12, wherein the processor is further configured to execute the computer program to, when adjusting the target window from the first display state to the second display state:
obtain the second display zone; and
adjust a size of the target window to be same as the second display zone.

14. The electronic device according to claim 13, wherein the processor is further configured to execute the computer program to, when adjusting the size of the target window to be same as the second display zone, adjust the second display zone to be a quadrilateral that overlaps with a non-target edge of the first display zone and is tangent to the target edge of the first display zone.

15. The electronic device according to claim 10, wherein the processor is further configured to execute the computer program to, when displaying the target part in the second display zone:
obtain the target part of the first graphical interaction interface; and
superimpose and display the target part on the first graphical interaction interface, the target part occupying the second display zone.

16. The electronic device according to claim 10, wherein the processor is further configured to execute the computer program to, when obtaining the first input operation, obtain the first input operation based on a target acquisition area.

17. The electronic device according to claim 16, wherein:
the display screen includes an outer edge and an inner edge;
the outer edge is a quadrilateral;
the inner edge is a closed arc, is close to a part of the outer edge, and does not overlap with the outer edge;
the target edge of the first display zone overlaps with the inner edge; and
the target acquisition area is located between the inner edge and the part of the outer edge.

18. The electronic device according to claim 10, wherein the processor is further configured to execute the computer program to, when obtaining the first input operation:
obtain, based on a target acquisition area, an input point of the target acquisition area; and
determine the first input operation based on the input point.

19. The electronic device according to claim 18, wherein:
the display screen includes an outer edge and an inner edge;
the outer edge is a quadrilateral;
the inner edge is a closed arc, is close to a part of the outer edge, and does not overlap with the outer edge;
the inner edge is the target edge; and
the target acquisition area is located between the inner edge and the first edge or is an area formed by the inner edge.

20. A non-transitory computer-readable storage medium storing a computer program that, when executed by a processor, causes the processor to:
display a target window in a first display zone of a display screen, a display area of the display screen including an arc edge, a target edge of the first display zone coinciding with the arc edge of the display area, and a target part of a first graphical interaction interface of the target window not being displayed;
in response to a first input operation, display the target part in a second display zone, the second display zone being part of the first display zone and not coinciding with the target edge of the first display zone; and
in response to a second input operation for the target part, display a second graphical interaction interface in the first display zone based on the target window.
